(19) United States
(12) Patent Application Publication
(10) Pub. No.: US 2013/0043826 A1
(43) Pub. Date: Feb. 21, 2013

(54) MODULAR AND PORTABLE BATTERY PACK POWER SYSTEM

(71) Applicants: Robert Emmett Workman, Morgan, UT (US); Norm Krantz, Logan, UT (US)

(72) Inventors: Robert Emmett Workman, Morgan, UT (US); Norm Krantz, Logan, UT (US)

(73) Assignee: Goal Zero LLC

(21) Appl. No.: 13/579,266

(22) PCT Filed: Feb. 23, 2011
(86) PCT No.: PCT/US11/25933

§ 371 Date: Oct. 31, 2012

Related U.S. Application Data
(60) Provisional application No. 61/308,712, filed on Feb. 26, 2010.
(60) Provisional application No. 61/349,735, filed on May 28, 2010.

(51) Int. Cl. H02J 1/00; H02J 7/00

(52) U.S. Cl. 320/101; 320/137; 307/18

(57) ABSTRACT

A battery pack power system includes a plurality of modular, portable, battery modules having various capacities that can be mixed and matched with one another to suit any of a wide variety applications or provide the desired power to any of a wide variety of loads at off-grid locations. The individual battery modules are stackable or otherwise nestable or connectable with one another to permit multiple users to each separately transport a module to a desired location and then combine the modules to assemble the battery power pack. One or more flexible connectors are provided for electrically chaining the assembled battery modules to one another and that permit only one-way, correct-orientation connection of the battery modules to one another, and have no exposed electrically conductive surfaces. An inverter module is connectable to any one of the battery modules, and operates to deliver 110 VAC in a first mode and 220 VAC in a second mode to provide electrical power to a wide variety of electrical loads. The battery power pack system is rechargeable from a portable solar photovoltaic power generator, wind power generator and/or hydropower generator connectable to one of the battery modules to recharge all of the battery modules.

### CROSS REFERENCE TO RELATED APPLICATIONS

This patent application claims the benefit of priority under 35 U.S.C. §119(e) of U.S. Provisional Application No. 61/349,735, having a filing date of May 28, 2010, titled “Modular and Portable Battery Pack Power System,” and U.S. Provisional Application No. 61/308,712, having a filing date of Feb. 26, 2010, titled “Modular and Portable Battery Pack Power System,” the complete disclosures of which are hereby incorporated by reference.

### FIELD

The present invention relates to a battery pack power system for providing power to a wide variety of electrical loads. The present invention relates more particularly to a modular and portable battery pack power system having individual battery modules of various capacities that are modular, portable, stackable, electrically chainable, reconfigurable, and rechargeable. The present invention relates more particularly to a modular and portable battery pack power system having individual battery modules that are nestable and/or connectable to one another to permit individual modules to be custom connected to one another in a building-block type manner and to be electrically chainable to one another in a plug-and-play type manner.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Rechargeable battery packs for providing power to electrical devices and accessories are generally known. However, many types of rechargeable battery packs come in fixed sizes that are not readily reconfigurable for use in a wide variety of applications. Typically, when a relatively high capacity is required, the corresponding battery pack tends to be prohibitively large and heavy and is not conveniently portable to suit the desired mobility of a user. Certain types of battery power packs are made up from multiple cells, but such cells are usually connected to one another by relatively permanent and inflexible connections, such as bus bars, cable and clamp connectors, and the like, that do not provide a desired degree of modularity and portability. Further, such known battery pack systems typically include electrical connections that are at least partially exposed, which may present shock and/or short circuit hazards.

Accordingly, It would be desirable to provide an improved battery pack power system that overcomes the disadvantages of the known battery pack power systems.

It would be desirable to provide an improved battery pack power system that is (among others) modular, portable, stackable, electrically chainable, reconfigurable, and rechargeable.

It would also be desirable to provide an improved battery pack system having individual modules that are capable of being transported separately (e.g. carried by different members of a group, etc.) to remote off-grid locations or outposts to provide power to electrical devices, and to be recharged by renewable sources, such as a compact, portable solar PV panel, or a portable wind power generator, or a portable hydropower generator.

It would also be desirable to provide an improved battery pack power system having individual battery modules of various capacities that can be mixed and matched (or otherwise reconfigured) with one another to suit any of a wide variety of applications or to provide the desired power to any of a wide variety of loads (i.e. electrical devices, appliances, tools, portable medical devices, etc.).

It would also be desirable to provide an improved battery pack power system having individual battery modules that are stackable or otherwise nestable or connectable with one another (e.g. in a ‘building block’ manner or the like) to create an assembly.

It would also be desirable to provide an improved battery pack power system that is ventilated in a manner that airflow is not obstructed when the modules are connected to one another.

It would also be desirable to provide an improved battery pack power system that has flexible electrical connectors for “chaining” or otherwise electrically connecting the individual battery modules to one another in a quick-connect manner (e.g. a ‘plug-and-play’ manner or the like) that permits only one-way, correct-orientation connection of modules to one another, and that features no exposed electrically conductive surfaces so that shock hazards to users are minimized and so that possibility of potential damage to the modules from short circuit contacts with external objects is minimized.

It would also be desirable to provide an improved battery pack power system that has individual battery modules with a charge indicator or meter that readily identifies the real-time remaining charge state of the battery module.

It would also be desirable to provide an improved battery pack power system that is rechargeable from a variety of sources including an electric grid connection (where available), and from a portable solar photovoltaic panel, a portable wind power generator, or a portable hydropower generator when an electric grid connection is not available.

It would also be desirable to provide an improved battery pack power system that is readily usable with loads that operate on both AC and DC power. It would also be desirable to provide an improved battery pack system with an inverter module having a ‘multi-standard’ plug that is configured to receive any of a wide variety of electric plug configurations (such as the various types of AC power cords associated with the AC electric power systems of different countries), or other plug configurations such as USB plugs, 12 VDC cigarette lighter plugs, 12 VDC barrel plugs, and the like.

It would also be desirable to provide an improved battery pack power system that has a readily accessible fuse box to facilitate troubleshooting of the battery module and permit fuses to be checked and replaced quickly and conveniently.

It would also be desirable to provide an improved battery pack power system that includes an inverter module that is connectable to any one of the battery modules, where the inverter is capable of operating at either 110 VAC or 220 VAC by activation of a switch, and includes an indicator (e.g. light, meter, etc.) identifying the output voltage, and includes a convenient on/off switch to minimize unintentional drain on the battery module(s).

It would be desirable to provide an improved battery pack power system that includes any one or more of these advantageous features.

### SUMMARY

According to one embodiment, a battery pack power system is provided that is (among others) modular, portable, stackable, electrically chainable, reconfigurable, and rechargeable. The system includes individual battery modules having various capacities that can be mixed and matched with one another to suit any of a wide variety applications or provide the desired power to any of a wide variety of loads (i.e. electrical devices, appliances, tools, portable medical equipment, communication devices, etc.). The individual battery modules are stackable or otherwise nestable or connectable with one another to permit one or more users to each separately carry or transport modules (e.g. in a pocket, or a backpack, or a purse, etc.) to a desired location (e.g. remote outpost, campsite, etc.) and then combine the modules to assemble the battery power pack (e.g. in a ‘building block’ manner or the like). The battery modules and/or an inverter module have a ventilation flow path that permits the free flow of air when the modules are connected to one another. The battery pack power system also includes flexible electrical connectors for “chaining” or otherwise electrically connecting the individual battery modules to one another (e.g. a ‘plug-and-play’ manner or the like) that permits only one-way, correct-orientation connection of modules to one another, and have no exposed electrically conductive surfaces. The modules further includes built-in storage ports or receptacles for retaining the flexible connectors when not in use. The individual battery modules include a charge indicator that identifies the real-time charge state of the module. The battery pack power system is rechargeable from a variety of sources including an electric grid connection, a vehicle 12 VDC connection, and a portable solar photovoltaic panel, portable wind power generator or portable hydropower generator and is readily usable with loads that operate on both AC and DC power. The battery pack power system also includes an inverter module having a ‘multi-standard’ socket configured to receive any of a wide variety of electric plug configurations, and includes sockets configured to receive other plug configurations including USB plugs. The battery modules include a readily accessible fuse box with a spring-biased door (e.g. cover, flap, etc.) to facilitate troubleshooting of the battery module and permit fuses to be checked and replaced quickly and conveniently. The inverter module is connectable to any one of the battery modules, and operates at either 110 VAC or 220 VAC by activation of a voltage selector switch, and includes an indicator light identifying the output voltage level, and includes an on/off switch to minimize unintentional drain on the battery module(s).

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic image of a front perspective view of a battery module for a battery pack power system with independent and stackable battery pack modules according to an exemplary embodiment.

FIG. 2 is a schematic image of a front perspective view of an inverter module for a battery pack power system with independent and stackable battery pack modules according to an exemplary embodiment.

FIG. 3 is a schematic image of a rear perspective view of the battery module of FIG. 1, including the flexible electrical connector and its storage receptacles, and fuse box door according to an exemplary embodiment.

FIG. 4 is a schematic image of a rear perspective view of a battery pack power system with different size battery modules and an inverter nested together and interconnected by flexible electrical connectors in a chained, plug-and-play manner, according to an exemplary embodiment.

FIG. 5 is a schematic image of a rear perspective view of a battery pack power system with several same-size battery modules nested together and secured to one another and electrically interconnected by a flexible electrical connector in a chained, plug-and-play manner, according to an exemplary embodiment.

FIG. 6 is a schematic image of a perspective view of a battery pack power system with several same-size battery modules with nesting receptacles to facilitate nesting the battery modules together. E nested modules are secured to one another and electrically interconnected by a flexible electrical connector in a chained, plug-and-play manner, and providing power to an accessory (shown by way of example as a 3 watt LED lamp module) according to an exemplary embodiment.

FIG. 7 is a schematic image of another perspective view of a battery pack power system of FIG. 6 with several same-size battery modules with nesting elements configured to mate with (and be received within) the nesting receptacles on an adjacent battery module to facilitate nesting the battery modules together. The nested battery modules are secured to one another and electrically interconnected by a flexible electrical connector in a chained, plug-and-play manner, and providing power to an accessory (shown as a lamp module) according to an exemplary embodiment.

FIG. 8 is a schematic image of a perspective view of an off-grid solar photovoltaic recharging system for the battery pack power system according to an exemplary embodiment.

FIG. 9 is a schematic image of a perspective view of a grid-accessible recharging system for the battery pack power system according to an exemplary embodiment.

FIG. 10 is a schematic image of a top view and several perspective views of a battery pack power system including a stack of different-sized battery pack modules and an inverter module nested with one another according to an exemplary embodiment.

FIG. 11 is a schematic image of several elevation views of a battery pack power system including a stack of different-sized battery pack modules and an inverter module nested with one another according to an exemplary embodiment.

FIG. 12 is a schematic image of several elevation views and bottom views of a battery pack power system including a stack of different-sized battery pack modules and an inverter module nested with one another according to an exemplary embodiment.

FIG. 13 is a schematic image of a top view and several perspective views of a first-size battery pack module according to an exemplary embodiment.

FIG. 14 is a schematic image of side and end elevation views of a first-size battery pack module according to an exemplary embodiment.

FIG. 15 is a schematic image of a top view and a bottom views of a first-size battery pack module according to an exemplary embodiment.

FIG. 16 is a schematic image of top and bottom views of another-size battery pack module, showing nesting receptacles and nesting elements according to an exemplary embodiment.

FIG. 17 is a schematic image of several perspective views of another-size battery pack module according to an exemplary embodiment.

FIG. 18 is a schematic image of side and end elevation views of another-size battery pack module according to an exemplary embodiment.

FIG. 19 is a schematic image of a top view, a bottom view and several perspective views of an inverter module according to an exemplary embodiment.

FIG. 20 is a schematic image of a side and end elevation views of an inverter module according to an exemplary embodiment.

FIG. 21 is a schematic image of a perspective view of a battery pack power system with independent and stackable battery pack modules according to another exemplary embodiment.

FIG. 22 is a schematic image of a perspective view of the battery pack power system of FIG. 21 with a flexible connector interconnecting individual battery modules according to an exemplary embodiment.

FIG. 23 is a schematic image of a perspective view of the battery pack power system of FIG. 21 with an inverter coupled to one of the individual battery modules according to an exemplary embodiment.

FIG. 24 is a schematic image of a perspective view of the battery pack power system of FIG. 21 with an inverter coupled to one of the individual battery modules and a flexible connector interconnecting the individual battery modules according to an exemplary embodiment.

FIG. 25 is a schematic image of another perspective view of the battery pack power system of FIG. 21 with an inverter coupled to one of the individual battery modules and a flexible connector interconnecting the individual battery modules according to an exemplary embodiment.

FIG. 26 is a schematic image of another perspective view of the battery pack power system of FIG. 21 with an inverter coupled to one of the individual battery modules and a flexible connector interconnecting the individual battery modules according to an exemplary embodiment.

FIG. 27 is a schematic image of a perspective view of an individual battery module for the battery pack power system of FIG. 21 according to an exemplary embodiment.

FIG. 28 is a schematic image of a front elevation view of an individual battery module for the battery pack power system of FIG. 21 according to an exemplary embodiment.

FIG. 29 is a schematic image of a rear elevation view of an individual battery module for the battery pack power system of FIG. 21 according to another exemplary embodiment.

FIG. 30 is a schematic image of a right side elevation view of an individual battery module for the battery pack power system of FIG. 21 according to an exemplary embodiment.

FIG. 31 is a schematic image of a left side elevation view of an individual battery module for the battery pack power system of FIG. 21 according to an exemplary embodiment.

FIG. 32 is a schematic image of a top view of an individual battery module for the battery pack power system of FIG. 21 according to an exemplary embodiment.

FIG. 33 is a schematic image of a bottom view of an individual battery module for the battery pack power system of FIG. 21 according to an exemplary embodiment.

### DETAILED DESCRIPTION

Before turning to the Figures, which illustrate the exemplary embodiments in detail, it should be understood that the application is not limited to the details or methodology set forth in the description or illustrated in the figures. It should also be understood that the terminology is for the purpose of description only and should not be regarded as limiting.

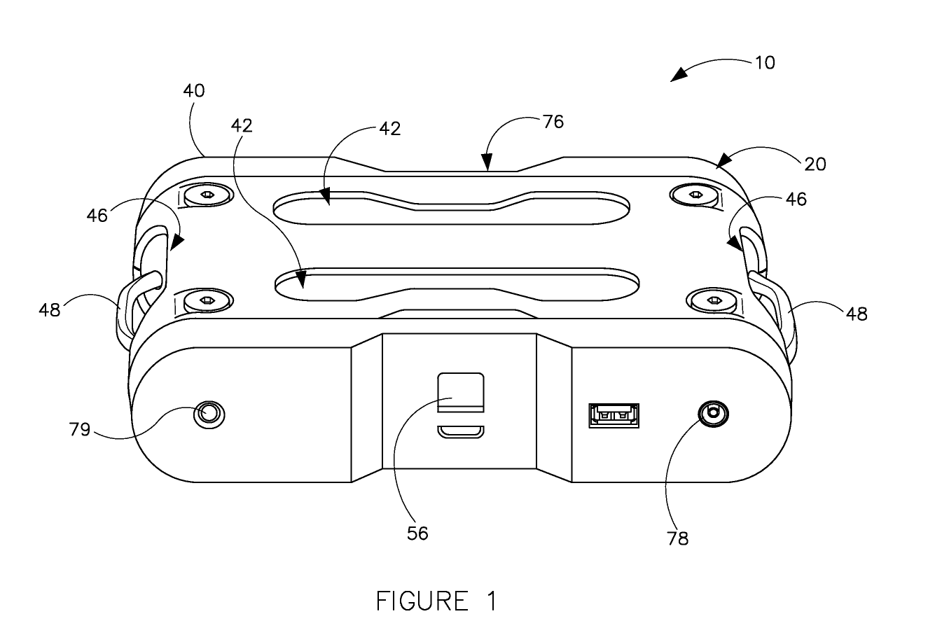

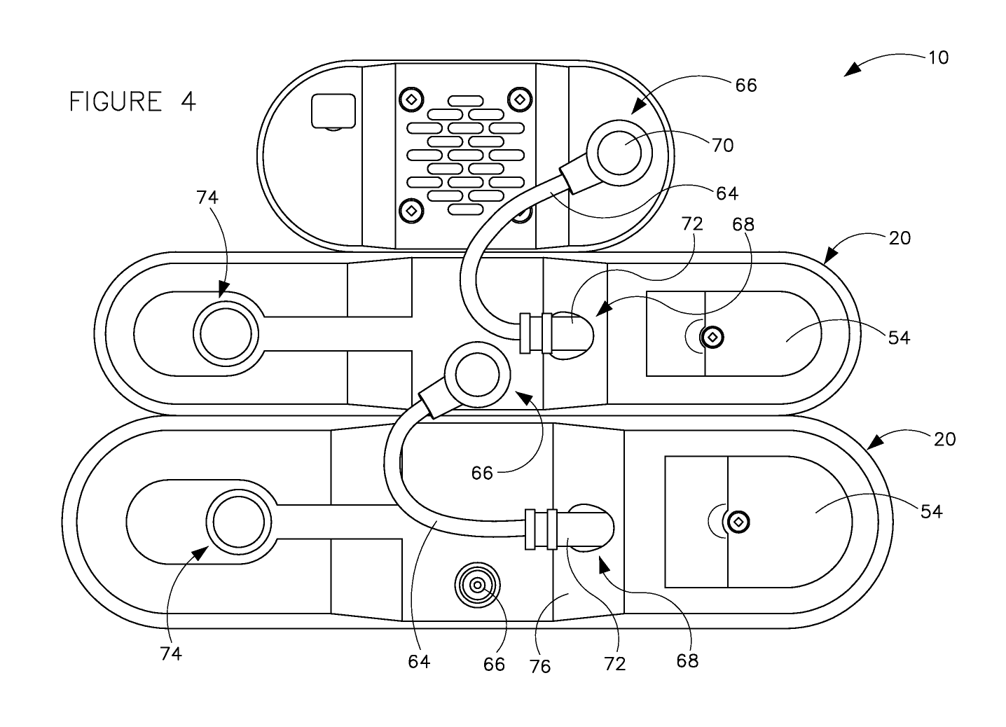

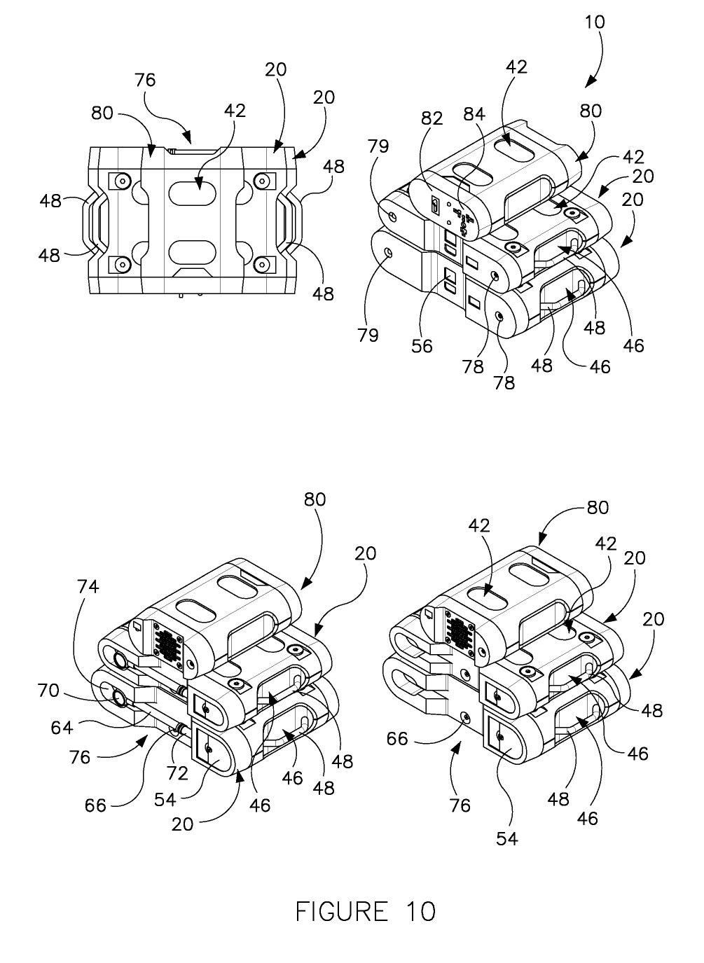

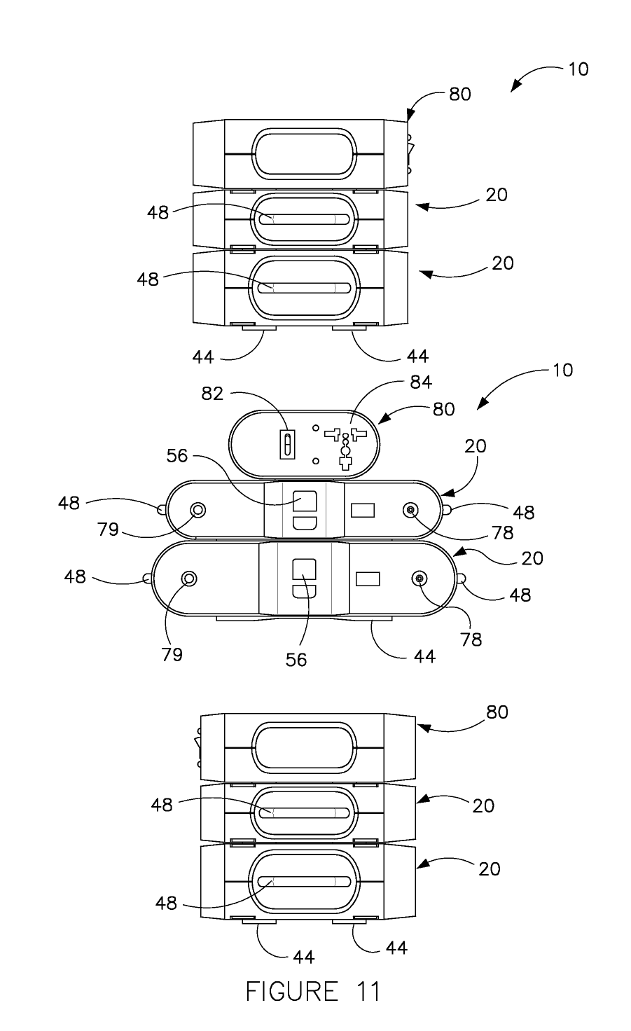

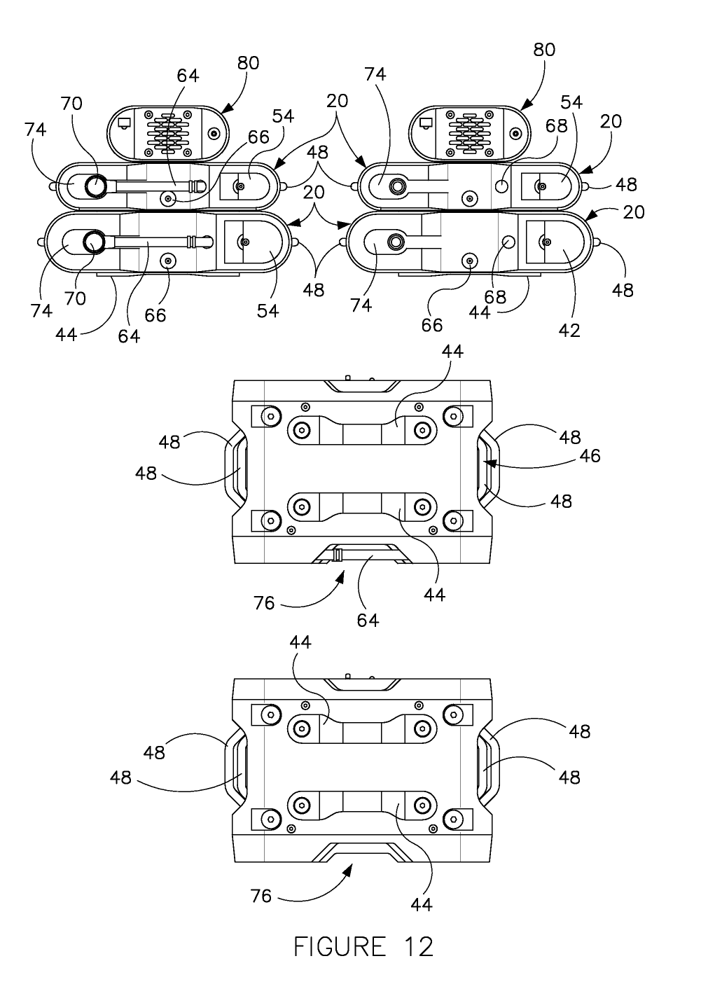

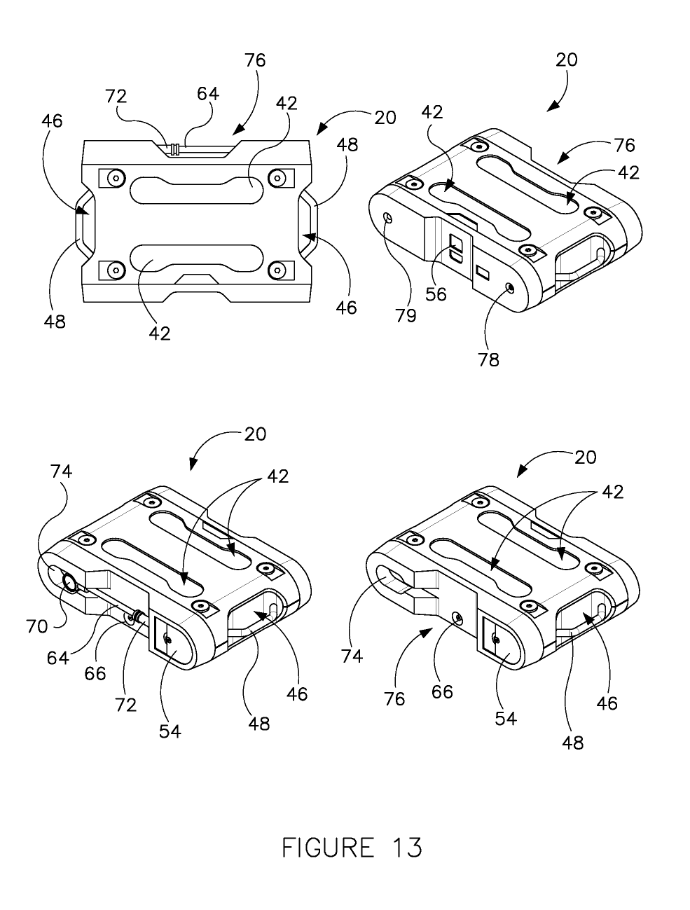

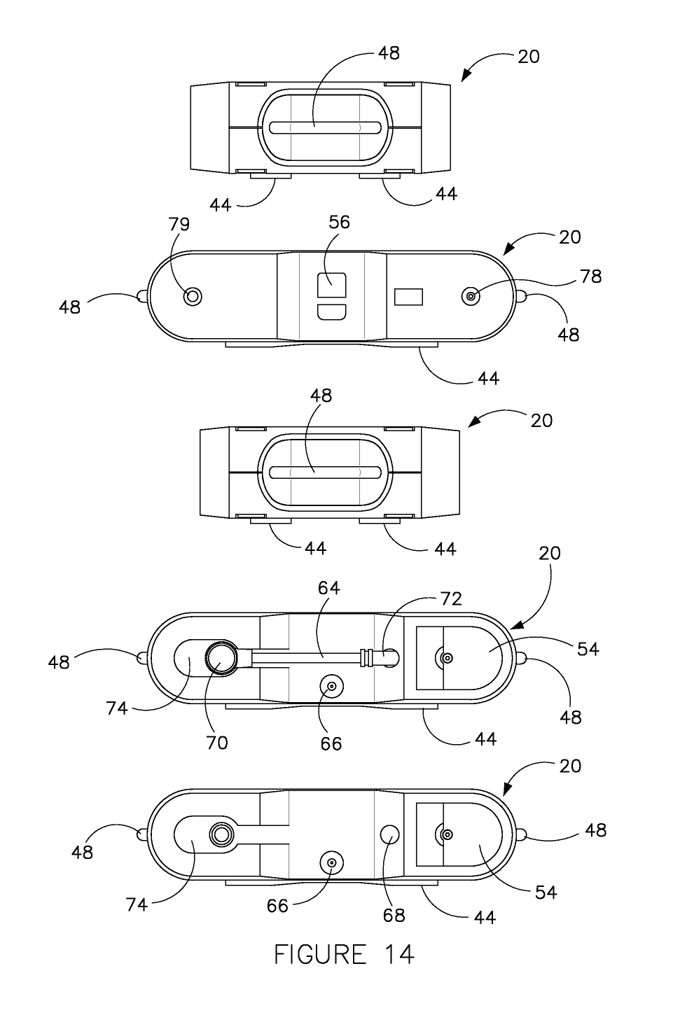

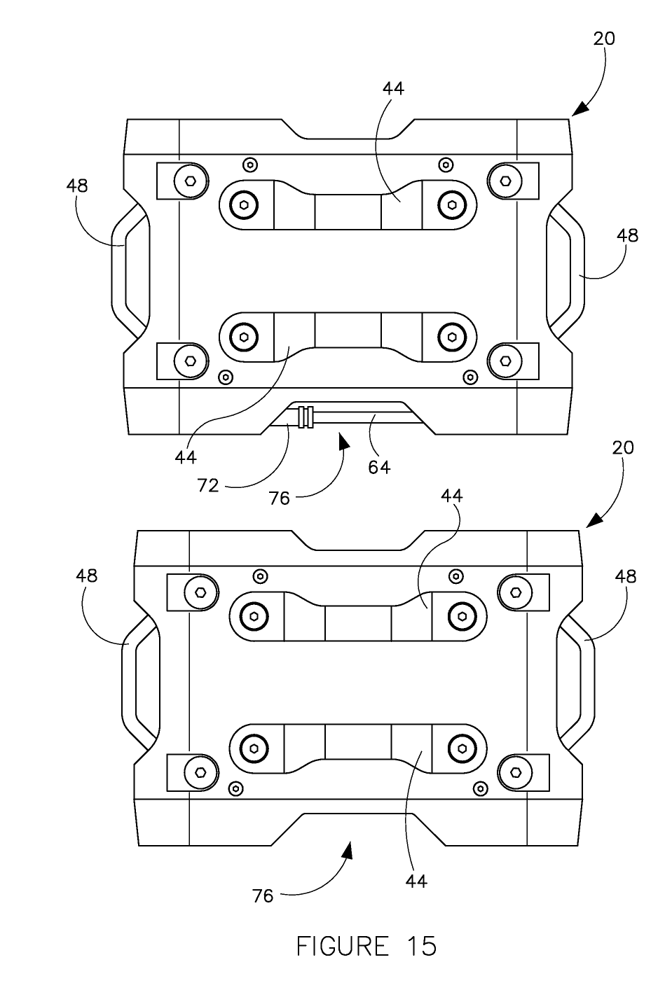

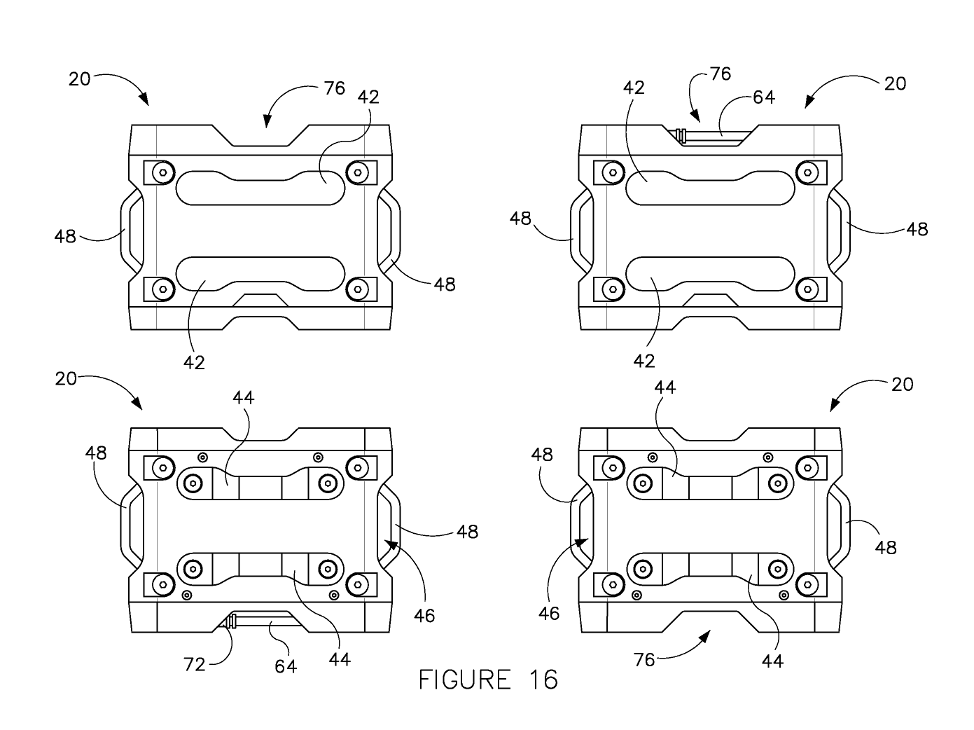

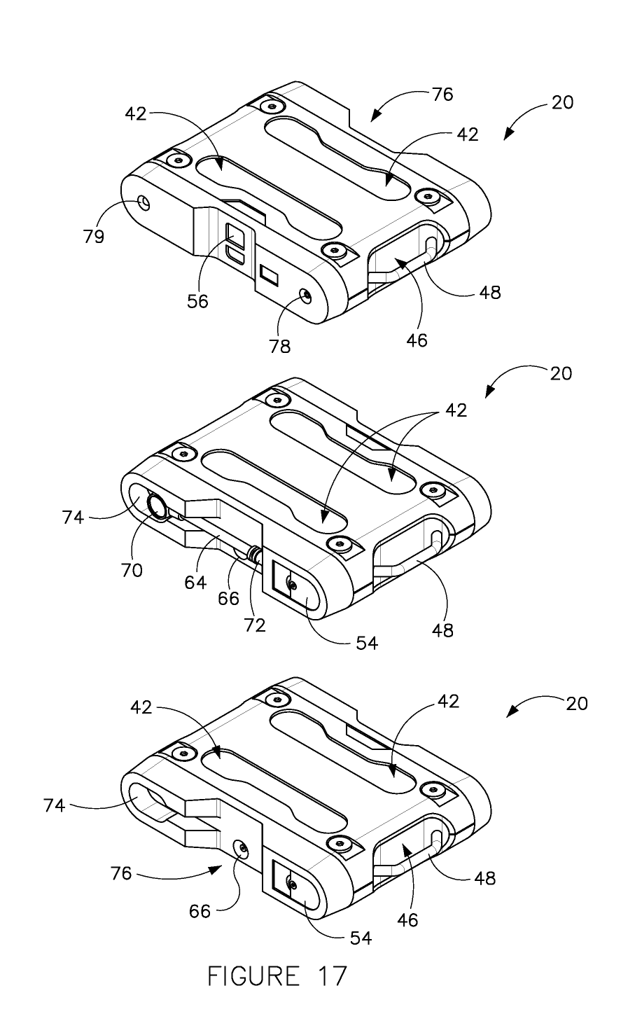

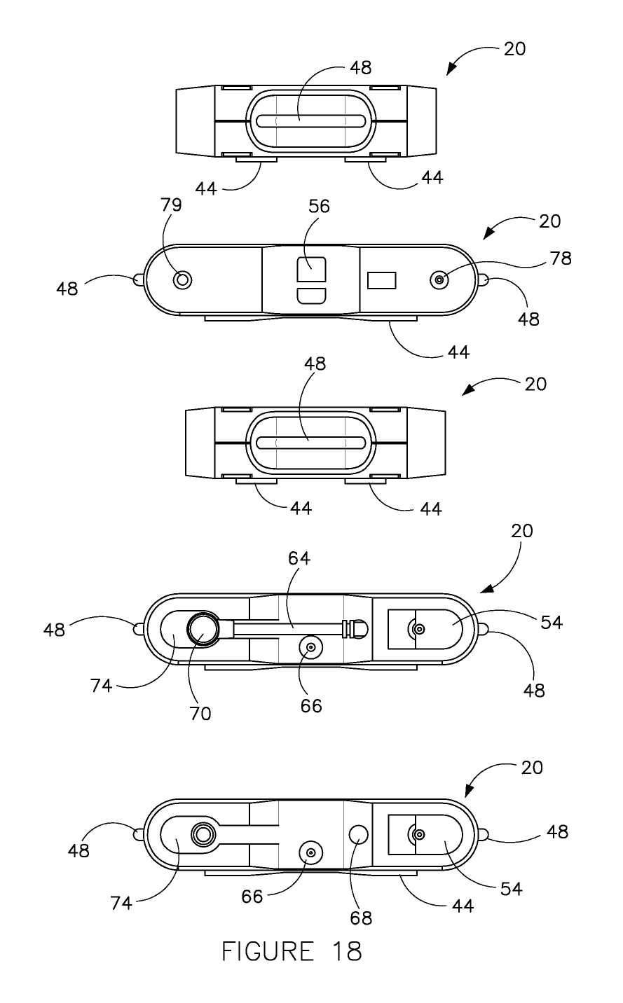

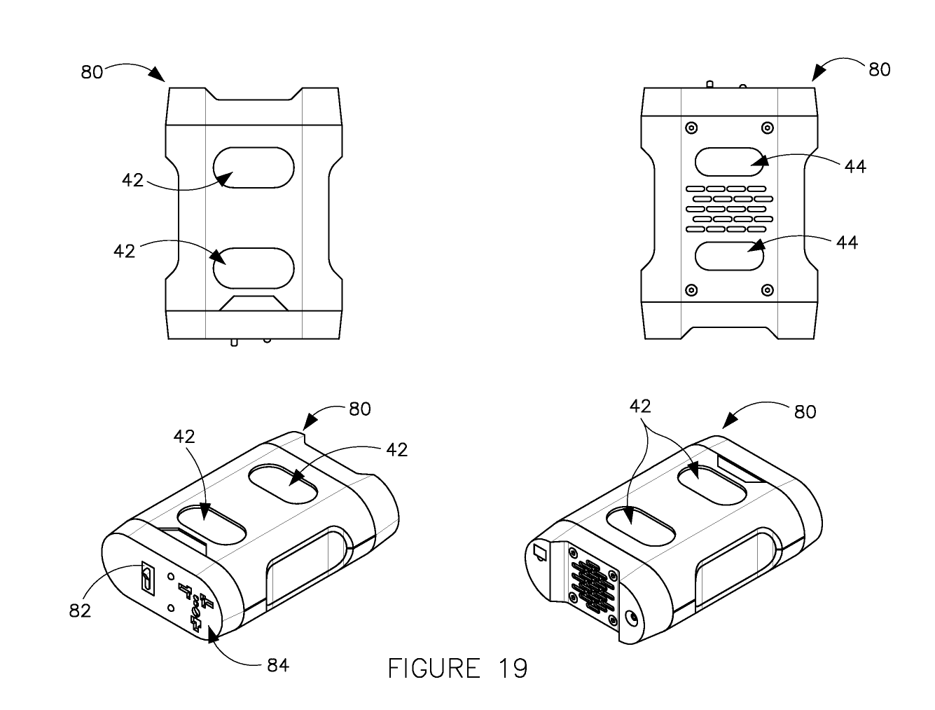

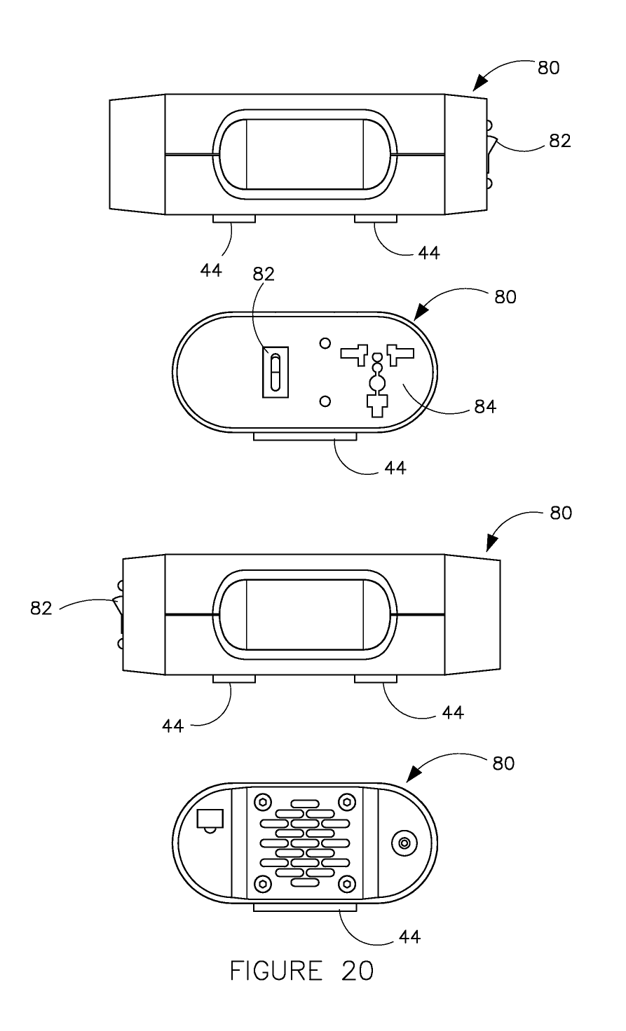

Referring to FIGS. 1-20, a battery pack power system 10 is shown according to a first exemplary embodiment. The battery pack power system 10 is shown to include a plurality of individual battery modules 20 (shown for example as two in FIGS. 4-12). The individual battery modules 20 may be provided in any of a variety of capacities so that a suitable number of battery modules 20 can be selected and combined to provide a desired power pack to suit an intended application and load device. According to one embodiment, a first-size battery module has a capacity of 120 watt-hours, and another-size battery module has a capacity of 50 watt-hours, and each battery module comprises a lithium ion phosphate battery material. However, according to alternative embodiments, other battery materials may be used, and any of a wide variety of capacities may be provided.

The battery modules 20 are also provided with electronic components including (among others) an input protection circuit, and output protection circuit, a charge controller, an LCD display controller and a temperature controller. The input protection circuit includes an input port that will shut down when the temperature exceeds a predetermined level (e.g. approximately 50 degrees C., etc.) to protect the battery from being overcharged, overheated or otherwise damaged. The output protection circuit includes output connection ports (e.g. inverter connection port, 12 VDC connectors, etc.) and other suitable electronic components for delivering electrical power from the battery to the outlet ports. The input and output ports are protected by a fuse having a suitable rating (e.g. 20 amps, etc.). The charge controller circuit regulates the charge to the battery module and includes protection by a readily accessible fuse, and also high temperature protection. The LCD display circuit detects the voltage of the battery and controls the LCD display that indicates the real-time charge of the battery module (e.g. 20%, 40%, 60%, 80%, Full, etc.). The Temperature controller includes a temperature detector that monitors the ground and DC input, such that when the temperature sensed by the detector exceeds a predetermined setpoint (e.g. approximately 50 degrees C. for example), it will cut power off. According to other embodiments, other control circuits, devices and components may be provided to suit particular applications and functions for the battery modules. An AC wall outlet adapter may also be provided that is operable to receive an electrical power input within the range of 100-240V AC, 50/60 Hz, and provide an output of approximately 15.3V DC, 3000 mA. A DC adapter may also be provided that provides power from a source such as a cigarette type lighter in a motor vehicle.

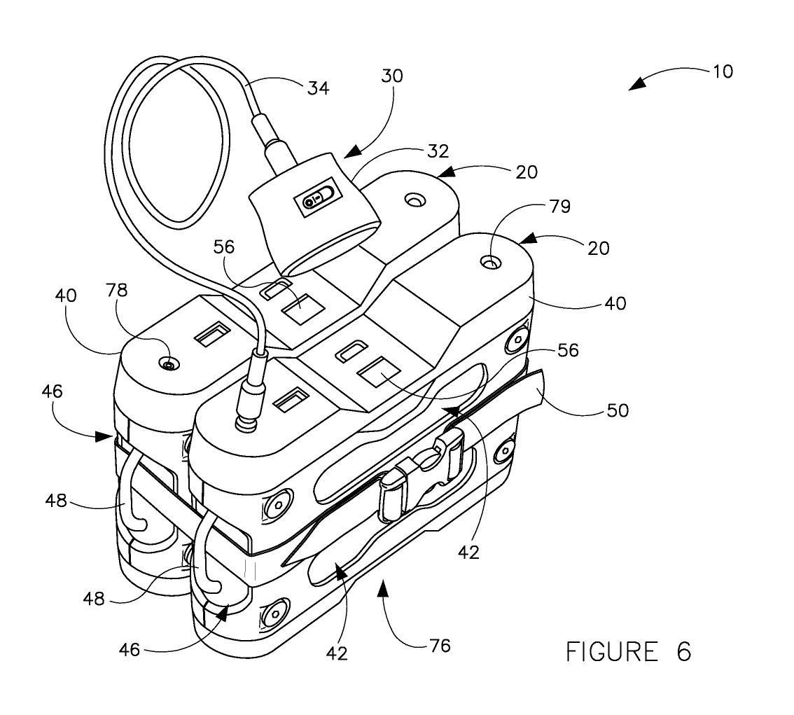

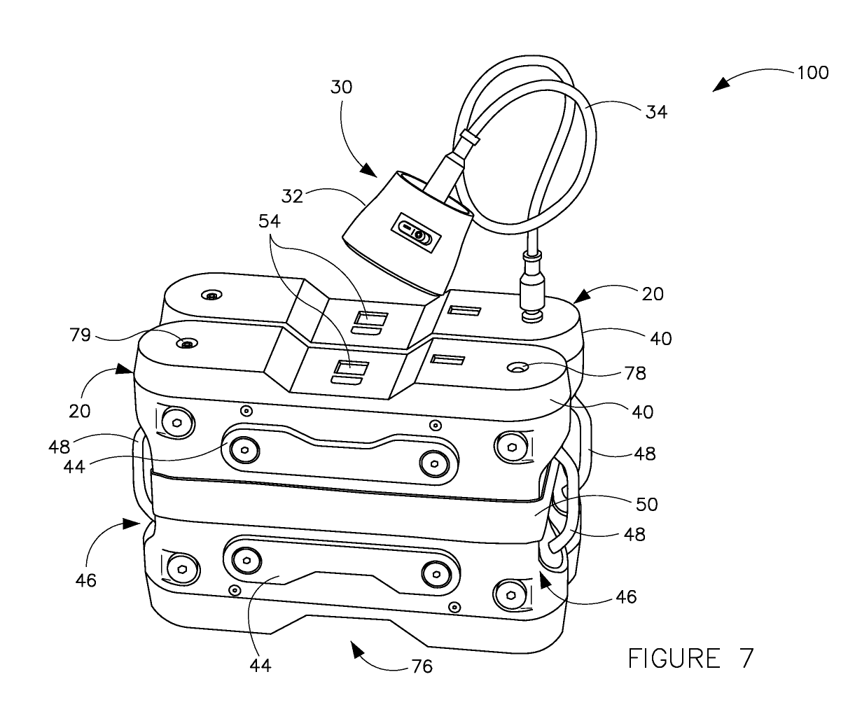

According to the illustrated embodiment of FIGS. 1-20, the modular nature of the individual battery modules 20 permits the modules to be custom-assembled into any desired configuration to power a desired load, and then readily disassembled and then reassembled in a different configuration to power another load application. The modular nature of the individual battery modules 20 permits the battery pack power system 10 to be separated into individual components or modules that are each more readily transported (e.g. by a single individual). For example, when desired for use at locations where transport of the assembled battery power pack system is impractical, such as (for example) hiking, camping, exploring, expeditioning, rafting, canoeing, search and rescue missions, providing power to electrical devices in areas where power is unavailable (e.g. temporarily lost—such as following storms or other natural disasters; or non-existent—such as in certain underdeveloped regions in the world, etc.), the disassembled modules 20 may each be carried or otherwise transported by separate members of a group to the location, where the modules 20 of the system 10 may then be quickly and conveniently assembled into a particular battery pack power system that is suited for the intended electrical loading conditions or devices to be powered. According to the embodiment of FIGS. 6-7, the device may be a light 30, such as a high-intensity 3 watt LED lamp 32 shown to include a stiff bendable wire 32 that may be provided at the end of a long cord, or may be plugged directly into the battery 20 (as shown), or other desirable size or type of lamp. According to other embodiments, the device may be any suitable device intended for use in locations without ready access to a grid-based source of electricity. For example, the device to be powered may be a portable medical device such as (for example) a continuous positive airway pressure breathing machine (C-PAP) that would permit a user with a medical condition (e.g. sleep apnea, etc.) to be able to enjoy outdoor or other activities that involve sleeping away from home and without access to grid-based electricity. According to other embodiments, the medical device may be any portable device intended to assist with any medical condition that might permit the user to gain mobility by having a readily transportable and remotely rechargeable battery pack power supply system.

Referring further to the embodiment of FIGS. 1-20, the battery modules 20 are shown to include a housing 40 having a uniquely designed shape that is intended to facilitate transport, nesting or connection to one another, ventilation, and electrical chaining to one another. The housing 40 includes a generally rectangular shape with elongated recesses 42 (e.g. nesting receptacles—shown for example as two receptacles) on one side, and corresponding nesting elements 44 (e.g. feet, projections, etc.) on the opposite side that are configured to mate with, or otherwise be received and retained within the receptacles 42 of an adjacent battery module 20. According to one embodiment, the nesting elements 44 are made from a resilient material (e.g. rubber, etc.) and may include ‘tacky’ or other non-slip properties or characteristics to cushion the battery modules 20 against one another, and help minimize relative movement of the modules 20 with respect to one another when the modules 20 are nested and secured together as an assembly.

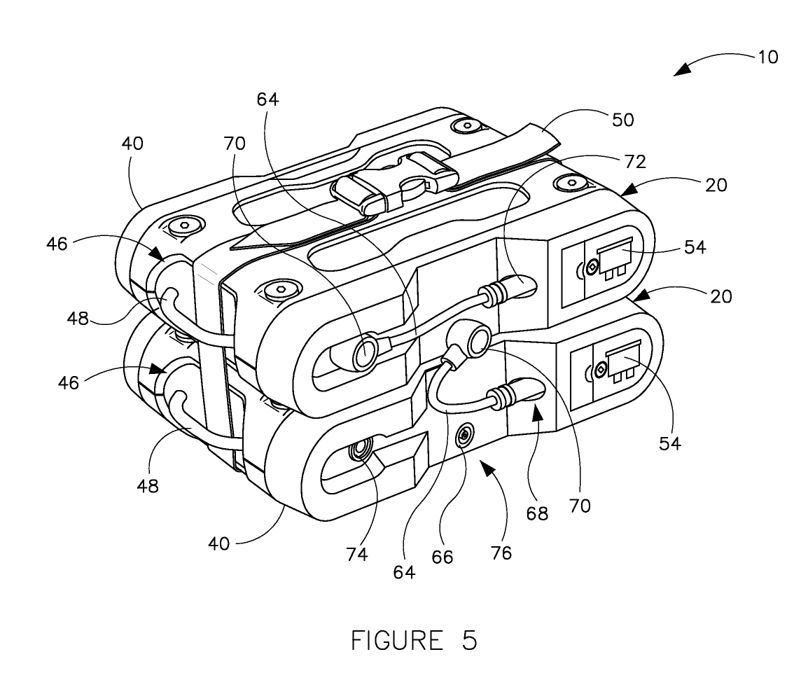

Referring to FIGS. 5-9, the modules 20 may also include a suitable recess 46 along the opposite side walls and a retainer link 46 (e.g. loop, bar, wire, etc.), that is configured to receive a retainer strap 50 that may be configured to extend substantially around all of the modules 20 in the battery pack system and then tightened and secured to hold the modules 20 in a desired nested configuration.

According to an alternative embodiment, the modules may include additional interlocking (or interconnecting) structure, such as by way of example, dovetail slide-locks or the like. According to other alternative embodiments, the modules may include a suitable device, such as a latch, catch, clasp, etc. to lock one module to another module, until released by a user. Although the assembled configuration of the modules is shown by way of example to be a vertically stacked and nested arrangement, the modules of the battery pack power system are also capable of being configured in horizontally nested configurations. The housing may be formed from any suitable material or combination of materials, such as plastic, aluminum, etc.

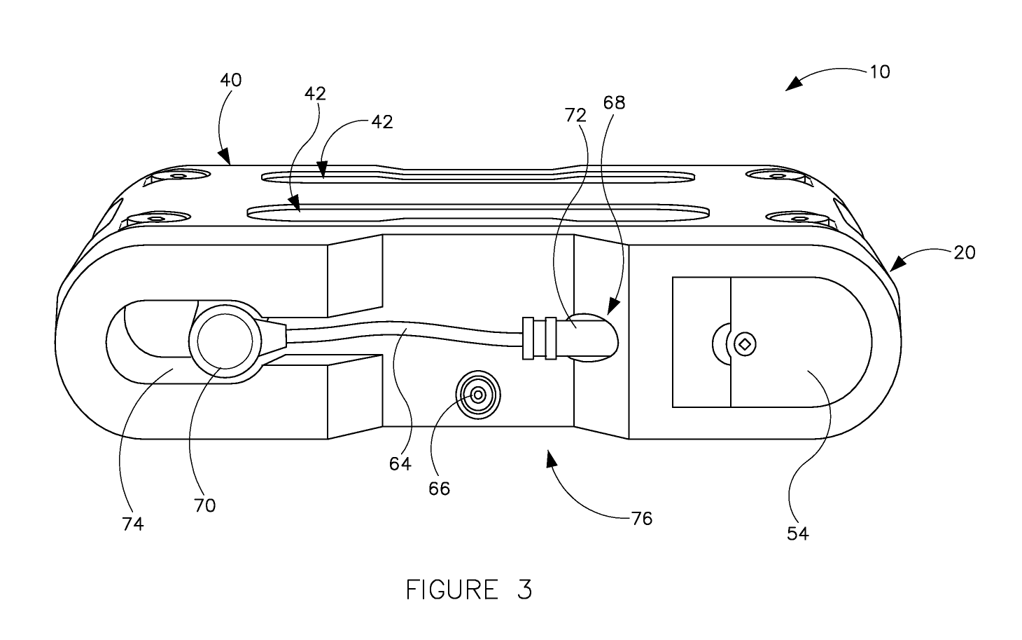

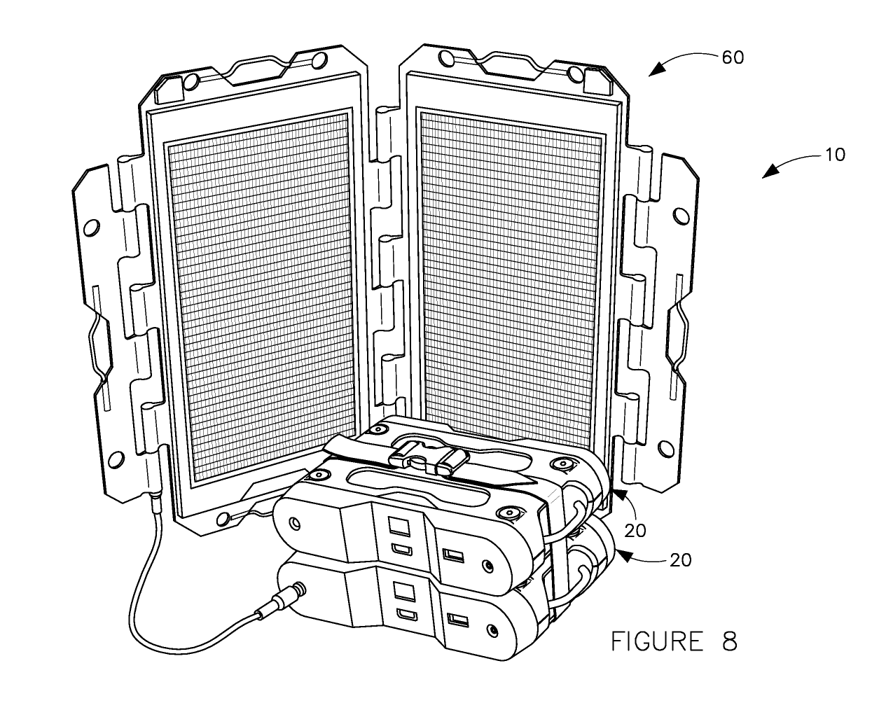

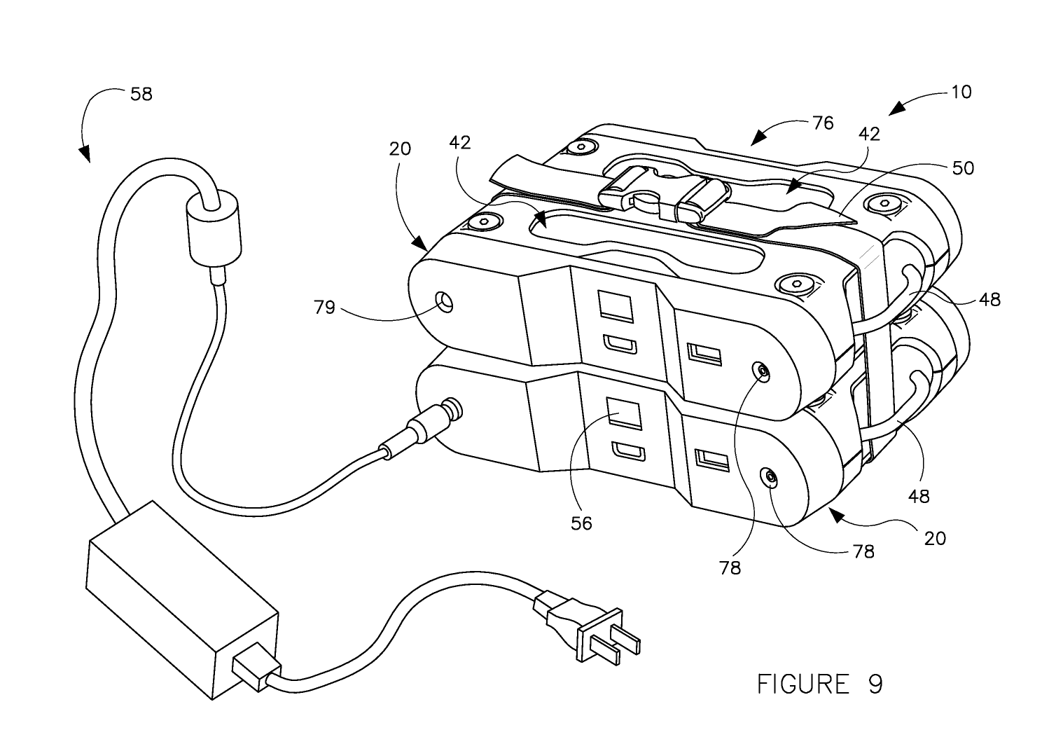

Referring further to FIGS. 3-5, the individual battery modules 20 also include a readily accessible fuse box 54 with a spring-biased door (e.g. cover, flap, etc.) to facilitate troubleshooting of the battery module and permit fuses to be checked and replaced quickly and conveniently. FIGS. 1 and 6-9 illustrate that the individual battery modules 20 include a charge indicator 56 that identifies the real-time charge state of the module 20. The battery modules 20 of the battery pack power system 10 are rechargeable via input connector 79 from a variety of sources including an electric grid connection (where available) using a suitable AC to DC converter 58 that plugs into a standard 110/220 V wall outlet (see FIG. 9), or off-grid sources such as a vehicle 12 VDC connection (where available), and renewable sources such as a portable solar photovoltaic panel 60 (shown by way of example as a folding, portable PV module in FIG. 8), a portable wind power generator, and/or a portable hydropower generator (not shown, e.g. when other sources are unavailable).

Referring further to FIGS. 3-5, the battery pack power system is shown to include a flexible connection device 64 (e.g. cable, etc.) that facilitates rapid and convenient electrical interconnection (e.g. “chaining”) of the battery modules 20 to one another, and to an individual module 20. According to the illustrated embodiment, the corresponding sockets 66, 68 on the modules have recessed electrical contacts that receive the mating barrel-type connector plugs 70, 72 on the flexible connection device 64, so that all live electrical contact surfaces are recessed to reduce the likelihood of inadvertent or unintentional contact that may cause shock or injury, or cause short circuits leading to damage of the components. The configuration of the plugs 70, 72 on the flexible connection device 64 permits only one-way, correct-orientation connection of modules 20 to one another. For example, the illustrated flexible connection device 64 has a first end with an in-line (e.g. coaxial) type connector 72, and a second end with a button-type connector 70 that extends generally perpendicular to the axis of the flexible connection device 64. When the flexible connection device 64 on one (or more) modules 20 is not in use, the button-type connector 70 on the second end can be safely stowed in a storage receptacle 74 to prevent loss or damage. The modules 20 are quickly and conveniently “chained” together electrically by simply removing the button-type connector 70 from the storage receptacle 74 and mating it with the corresponding chaining socket 66 on an adjacent unit 20. The next battery module 20 in the stack may then be chained to its next adjacent battery 20 in a similar manner (and so-on). The profile of the flexible electrical connector 64 is maintained at all times within the bottom boundary of the battery module 20 by strategic placement of a chaining recess 76 that contains the chaining socket 66 and the socket 68 for the first end of the flexible connection device.

The battery modules 20 of the system 10 may be used directly to provide DC power via output connector 78 to a wide variety of loads, and include suitable output connectors, such as (but not limited to) USB connectors, 12V barrel connectors, 12V cigarette lighter connectors, etc.

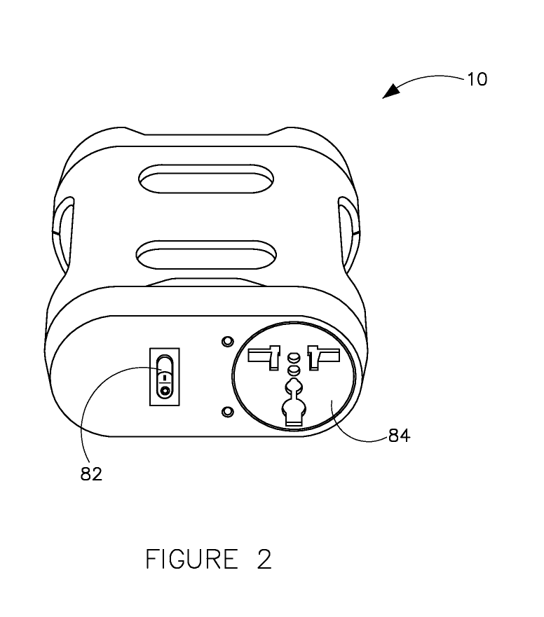

The battery modules 20 of the system may also be used with an inverter module 80 (see FIGS. 2 and 4)to provide AC power (e.g. 110 VAC, 220 VAC, etc.) to a wide variety of electrical load devices. The inverter module 80 is shown to nest directly any size battery module 20 and is retained in place by the nesting elements 44 and recesses 42 and secured by a retainer strap 50 (in a similar manner as previously described for the battery modules). The inverter module 80 includes a selector switch for operation at either 110 VAC or 220 VAC, and includes an indicator light identifying the output voltage level, and includes an on/off switch 82 to minimize unintentional drain on the battery module(s) 20. The inverter module 80 includes a number of output connectors, including a ‘multi-standard’ socket 84 configured to receive any of a wide variety of AC electric plug configurations, and includes sockets configured to receive other DC plug configurations including USB plugs, 12V barrel connectors, 12V cigarette lighter connectors, etc.

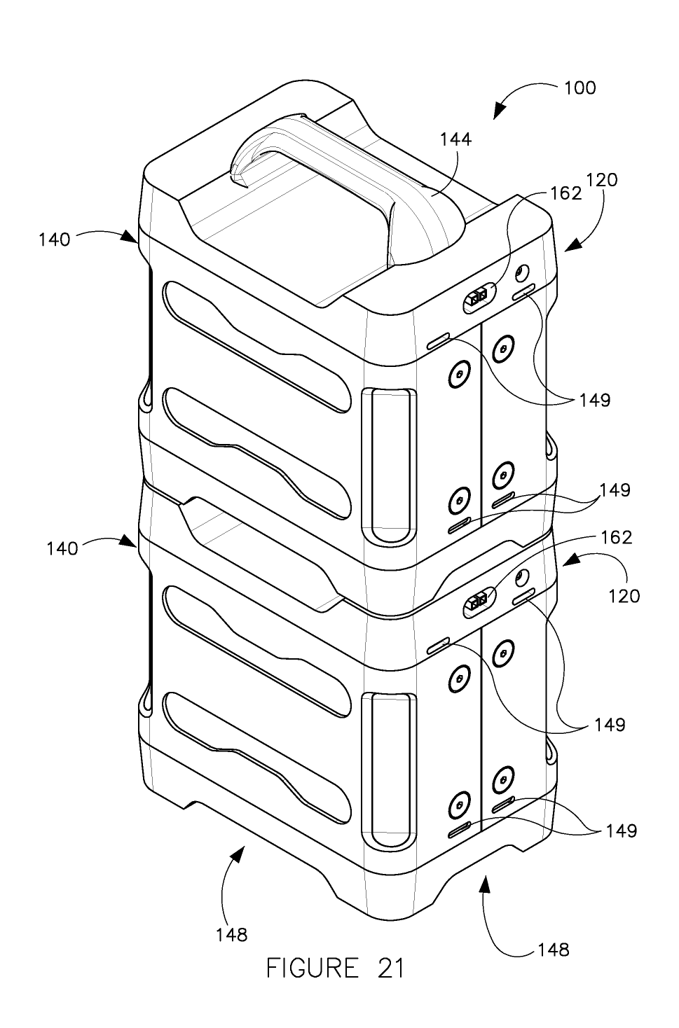

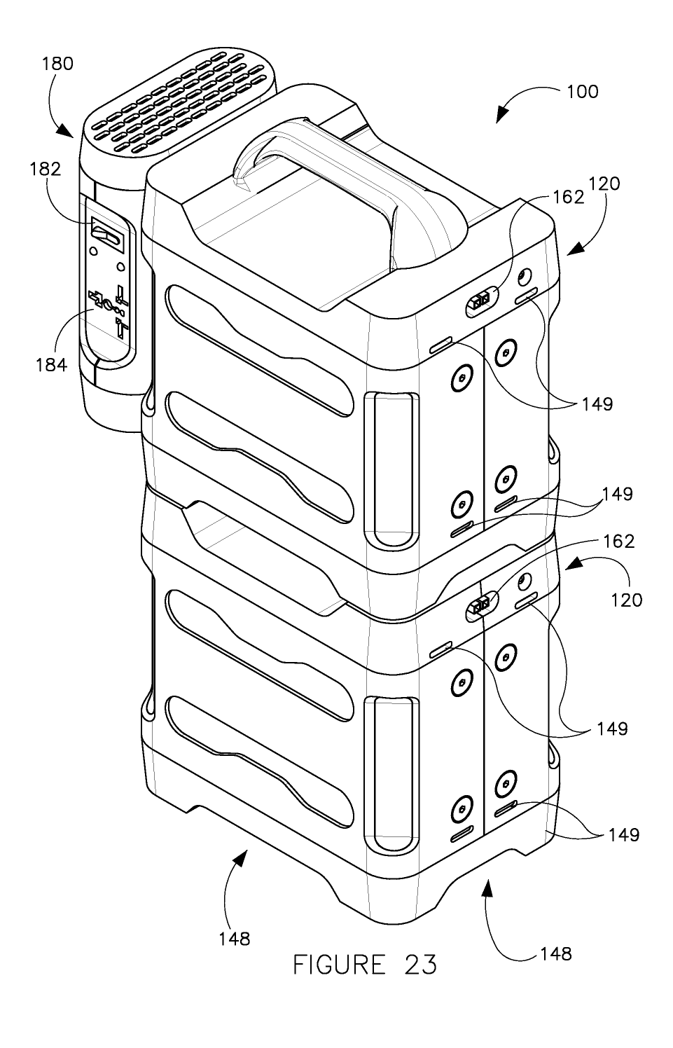

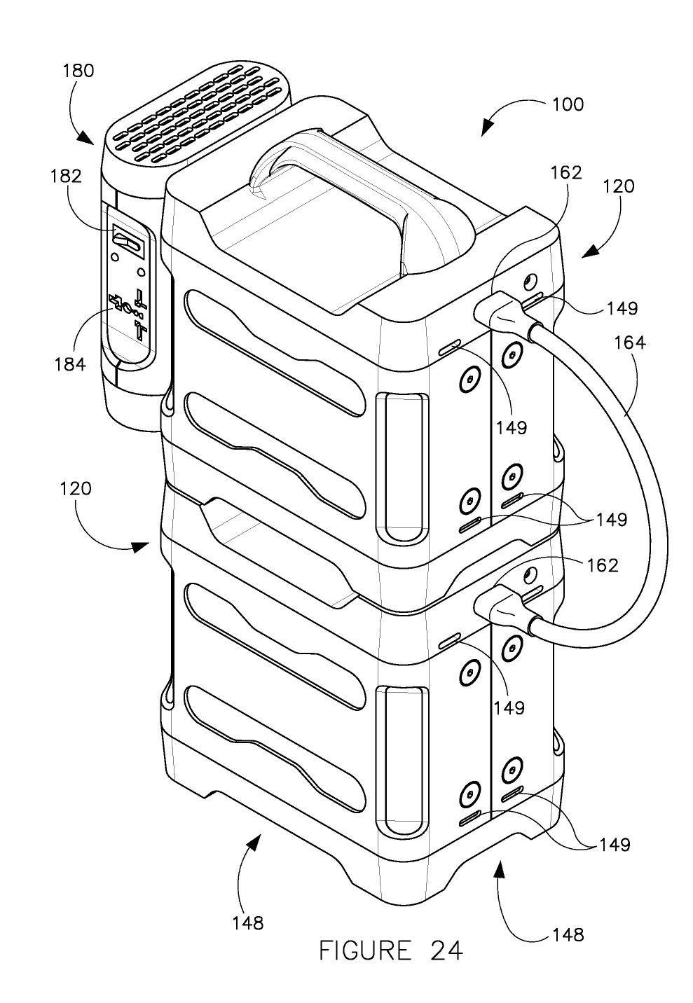

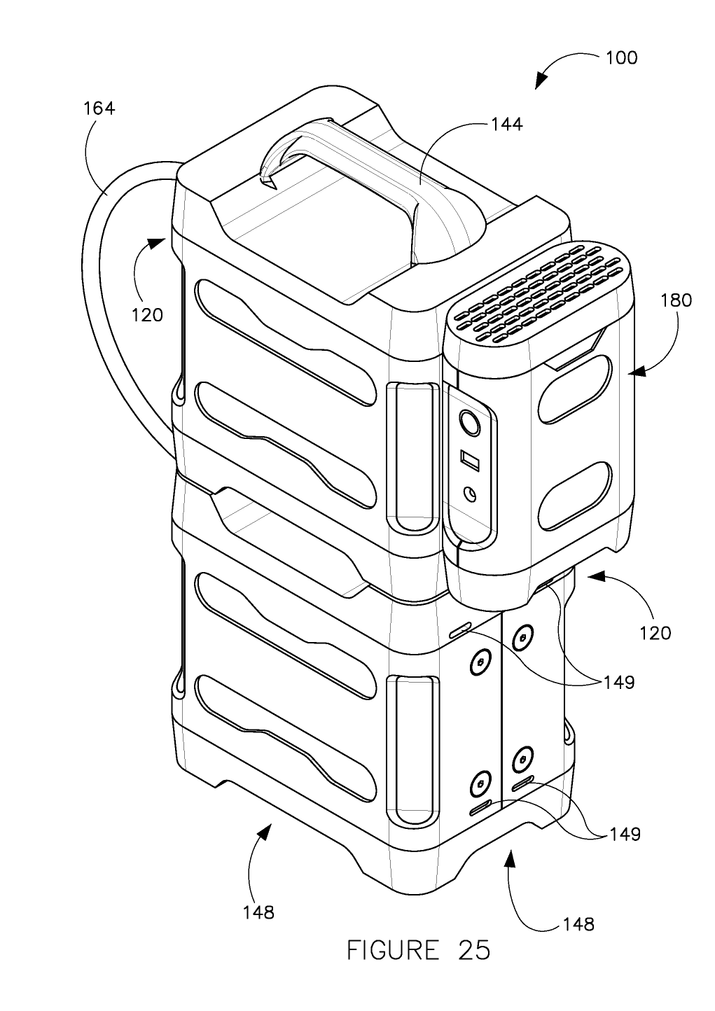

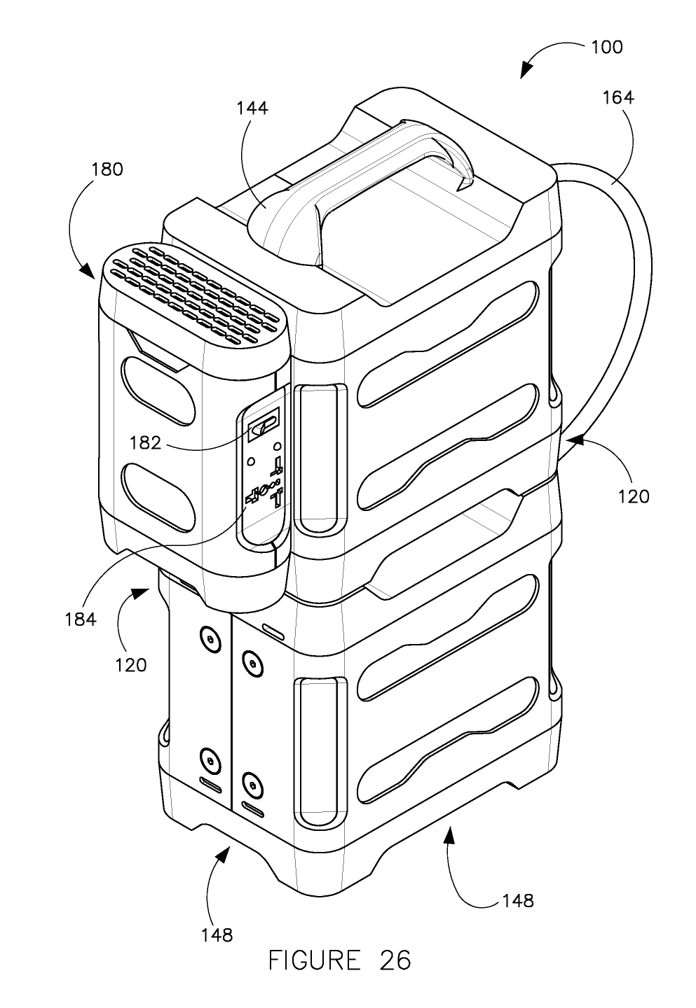

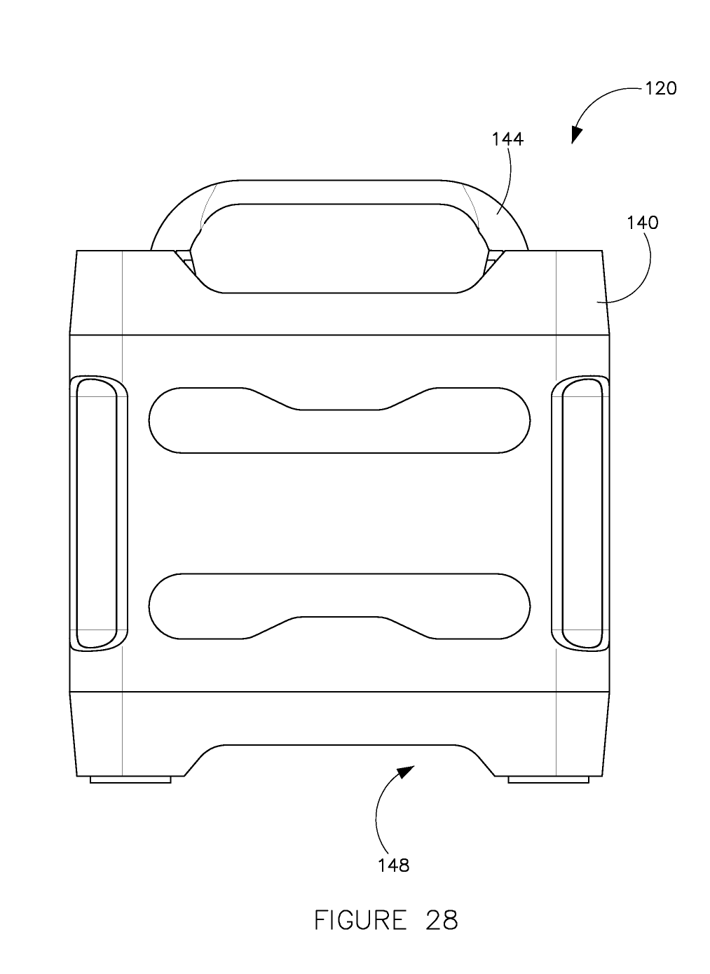

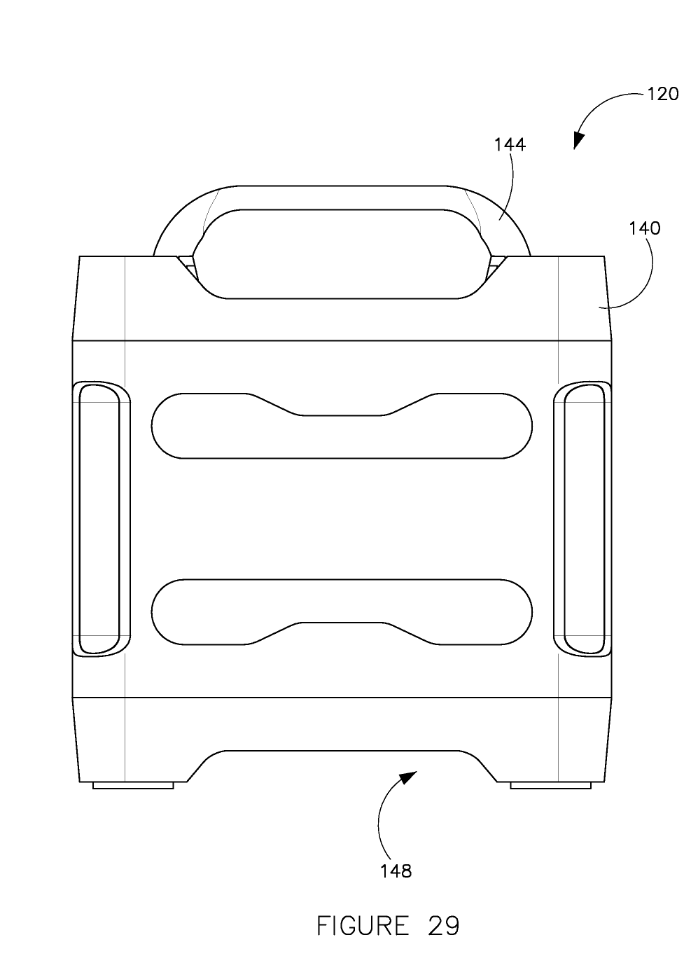

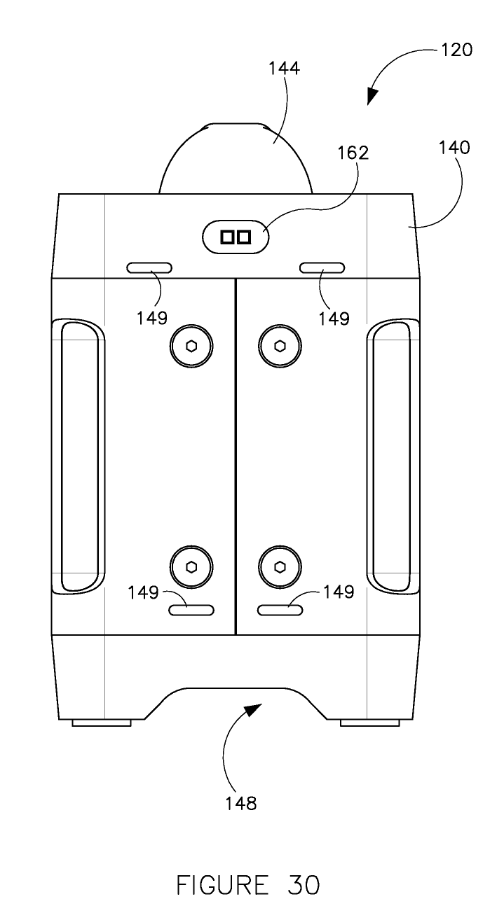

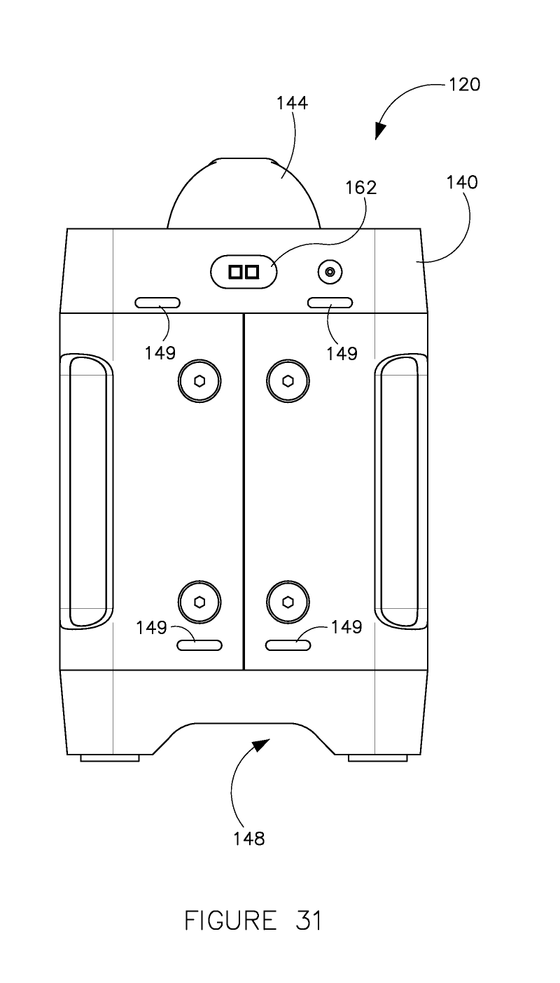

Referring to FIGS. 21-33, another battery pack power system 100 is shown by way of example as a relatively larger (yet still modular and portable) battery pack power system, according to an exemplary embodiment. The battery pack power system 100 of FIGS. 21-33 is shown to include a plurality of individual battery modules 120 (shown for example as two in FIGS. 21-26). The individual battery modules 120 may be provided in any of a variety of capacities so that a suitable number of battery modules 120 can be selected and combined to provide a desired power pack to suit an intended application and load device. According to one embodiment, the battery modules 120 have a capacity of approximately 400 watt-hours and comprise a lead-acid battery material. However, according to alternative embodiments, other battery materials may be used, and any of a wide variety of capacities may be provided.

The battery modules 120 are also provided with electronic components including (at least) an input protection circuit, and output protection circuit, a charge controller, an LCD display controller and a temperature controller. The input protection circuit includes an input port that will shut down when the temperature exceeds a predetermined level (e.g. approximately 50 degrees C., etc.) to protect the battery from being overcharged, overheated or otherwise damaged. The output protection circuit includes output connection ports (e.g. inverter connection port, 12 VDC connectors, etc.) and other suitable electronic components for delivering electrical power from the battery to the outlet ports. The input and output ports are protected by a fuse having a suitable rating (e.g. 20 amps, etc.). The charge controller circuit regulates the charge to the battery module and includes protection by a readily accessible fuse, and also high temperature protection. The LCD display circuit detects the voltage of the battery and controls the LCD display that indicates the real-time charge of the battery module (e.g. 20%, 40%, 60%, 80%, Full, etc.). The temperature controller includes a temperature detector that monitors the ground and DC input, such that when the temperature sensed by the detector exceeds a predetermined setpoint (e.g. approximately 50 degrees C. for example), it will cut power off. According to other embodiments, other control circuits, devices and components may be provided to suit particular applications and functions for the battery modules 120.

According to the illustrated embodiment, the modular nature of the individual battery modules 120 permits the modules to be custom-assembled into any desired configuration to power a desired load, and then readily disassembled and then reassembled in a different configuration to power another load application. The modular nature of the individual battery modules 120 permits the battery pack power system to be separated into individual components or modules that are each more readily transported (e.g. by a single individual). For example, when used in locations where transport of the assembled battery power pack system is impractical e.g. hiking, camping, exploring, expeditioning, search and rescue missions, providing power to electrical devices in areas where power is unavailable (e.g. temporarily lost—such as following storms or other natural disasters; or non-existent—such as in certain underdeveloped regions in the world, etc.), the disassembled modules 120 may each be transported by separate members of a group to the location, where the modules 120 of the system may then be quickly and conveniently assembled into a particular battery pack power system that is suited for the intended electrical loading conditions.

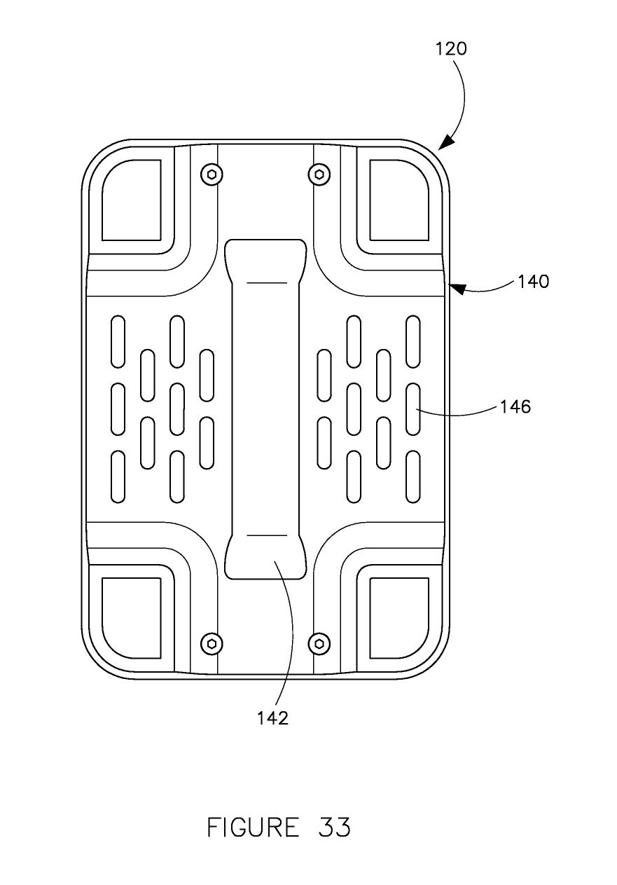

Referring further to FIGS. 21-33, the battery modules 120 are shown to include a housing 140 having a uniquely designed shape that is intended to facilitate transport, nesting or connection to one another, ventilation, and electrical chaining to one another. The housing 140 includes a generally rectangular shape with an elongated handle 144 extending lengthwise and projecting above the top surface of the module 120. The housing 140 also includes a recess 142 (e.g. pocket, well, receptacle, socket, etc. see FIG. 33) on a bottom surface of the module that is configured (e.g. shaped and sized, etc.) to securely receive the handle 144 from another module 120. The recess 142 may receive a handle 144 from an adjacent module 120 in any suitable manner, such as an interference fit, that is intended to keep the modules 120 connected to one another once assembled during normal usage. According to an alternative embodiment, the modules may include additional interlocking (or interconnecting) structure, such as by way of example, dovetail slide-locks or the like. According to other alternative embodiments, the modules may include a suitable device, such as a latch, catch, clasp, etc. to lock one module to another module, until released by a user. According to yet another alternative embodiment, the modules may also include a suitable recess along the front and rear walls, or the opposite side walls, that is configured to receive a retainer strap that may be configured to extend substantially around all of the modules in the battery pack system and then tightened and secured to hold the modules in a desired configuration. Although the assembled configuration of the modules is shown by way of example to be a vertically stacked and nested arrangement, the modules of the battery pack power system are also capable of being configured in horizontally nested configurations. The housing may be formed from any suitable material or combination of materials, such as plastic, aluminum, etc.

Referring further to FIG. 33, the housing 140 includes a number of apertures 146 (e.g. vents, slots, ports, etc.) that define a ventilation air flow path for the battery modules. The apertures are shown for example as arranged in a pattern on a recessed portion 148 of the bottom surface of the module (see FIG. 33), so that once nested with, or connected to, an adjacent module 120, a space is provided that permits air flow between the top of one module 120 and the bottom of another module 120 to be drawn in through the bottom of the module 120 and then out through apertures 149 arranged along the walls of the module. The ventilation design is intended to minimize openings on the top of the module to enhance resistance to weather elements, and to permit unimpeded air flow when the modules are nested one atop another.

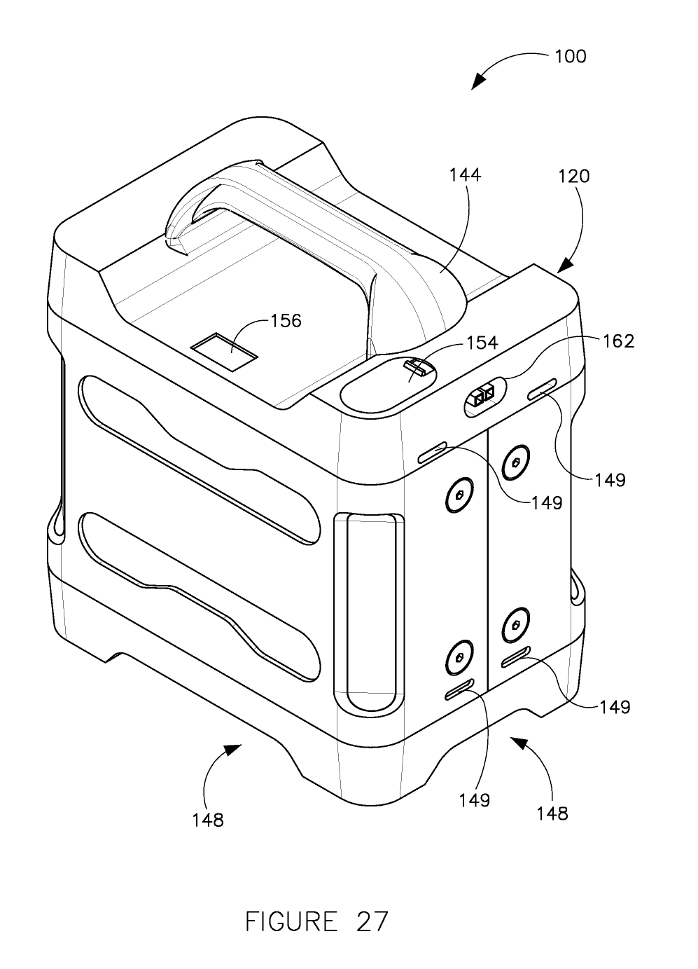

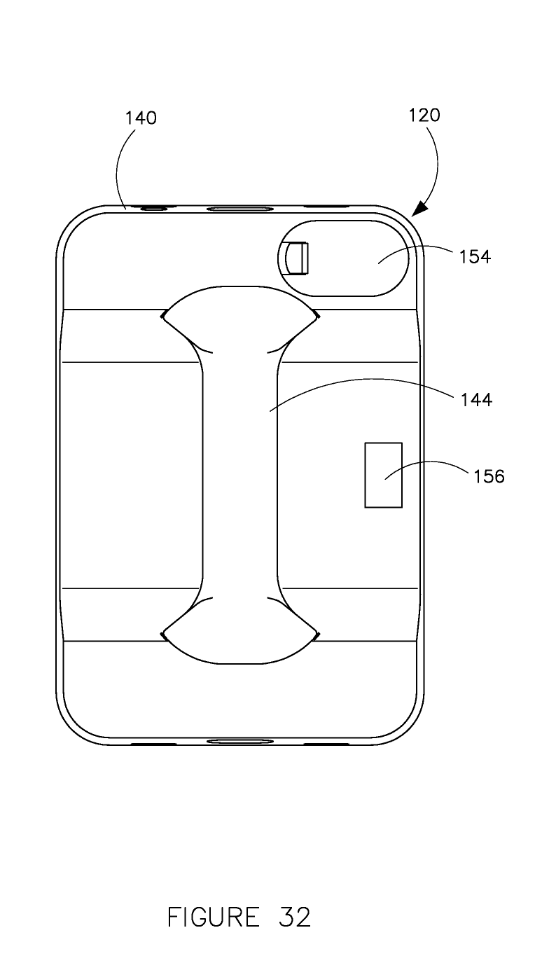

Referring further to FIGS. 27 and 32, the individual battery modules also include a readily accessible fuse box 154 with a spring-biased door (e.g. cover, flap, etc.) to facilitate troubleshooting of the battery module 120 and permit fuses to be checked and replaced quickly and conveniently. FIGS. 27 and 32 also illustrate that the individual battery modules 120 include a charge indicator 156 that identifies the real-time charge state of the module. The battery modules 120 of the battery pack power system are rechargeable from a variety of sources including an electric grid connection (where available), or off-grid sources such as a vehicle 12 VDC connection (where available), and renewable sources such as a portable solar photovoltaic panel, a portable wind power generator, and/or a portable hydropower generator (e.g. when other sources are unavailable).

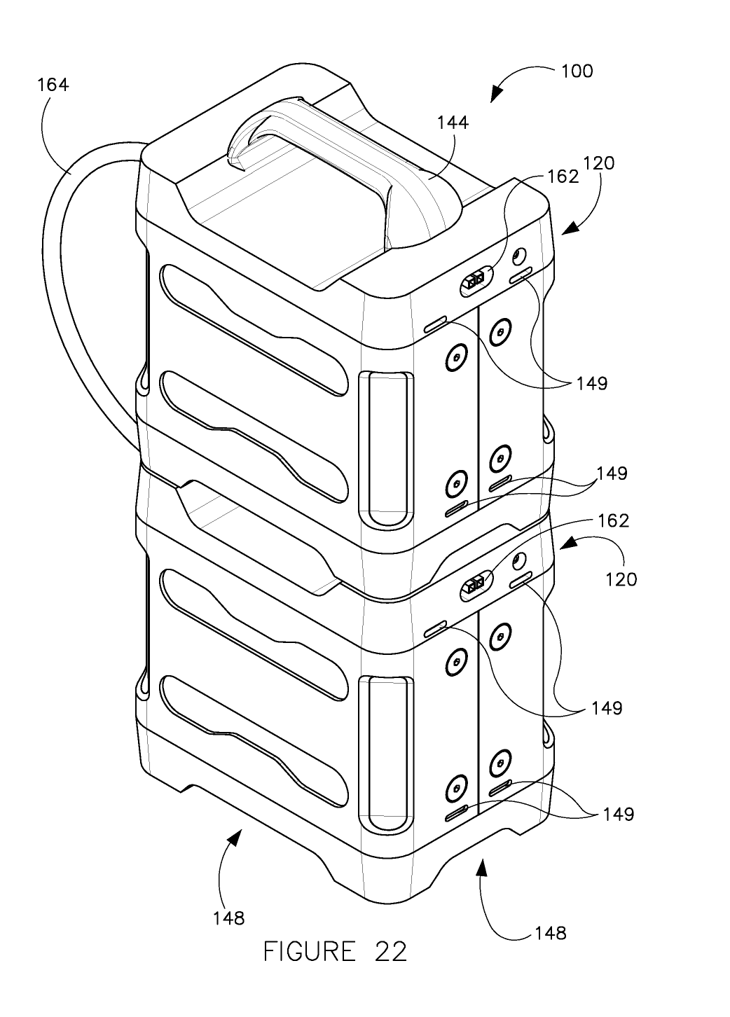

Referring further to FIGS. 22, 24, 25, the battery pack power system 100 is shown to include a flexible connection device 164 (e.g. cable, etc.) that facilitates rapid and convenient electrical interconnection (e.g. “chaining”) of the battery modules 120 to one another. According to the illustrated embodiment, the corresponding sockets on the modules 120 have recessed electrical contacts that receive the mating barrel-type connector plugs on the flexible connection device, so that all live electrical contact surfaces are recessed to reduce the likelihood of inadvertent or unintentional contact that may cause shock or injury, or cause short circuits leading to damage of the components. The configuration of the plugs on the flexible connection device permits only one-way, correct-orientation connection of modules to one another.

The battery modules 120 of the system may be used directly to provide DC power to a wide variety of loads, and include suitable output connectors, such as (but not limited to) USB connectors, 12V barrel connectors, 12V cigarette lighter connectors, etc.

The battery modules 120 of the system may also be used with an inverter module 180 to provide AC power (e.g. 110 VAC, 220 VAC, etc.) to a wide variety of electrical load devices. The inverter module 180 attaches directly to a side wall of the battery module 120 and is retained in place by a snug-fit electrical connection 162 with the battery module 120, and connectors (e.g. projections, tabs, etc.) that engage suitable recesses or slots on the wall of the module. The inverter module 180 includes a selector switch for operation at either 110 VAC or 220 VAC, and includes an indicator light identifying the output voltage level, and includes an on/off switch 182 to minimize unintentional drain on the battery module(s). The inverter module includes a number of output connectors, including a ‘multi-standard’socket 184 configured to receive any of a wide variety of AC electric plug configurations, and includes sockets configured to receive other DC plug configurations including USB plugs, 12V barrel connectors, 12V cigarette lighter connectors, etc.

It is also important to note that the construction and arrangement of the elements of the battery pack power system as shown schematically in the embodiments is illustrative only. Although only a few embodiments have been described in detail in this disclosure, those skilled in the art who review this disclosure will readily appreciate that many modifications are possible without materially departing from the novel teachings and advantages of the subject matter recited.

Accordingly, all such modifications are intended to be included within the scope of the present invention. Other substitutions, modifications, changes and omissions may be made in the design, operating conditions and arrangement of the preferred and other exemplary embodiments without departing from the spirit of the present invention.

Unless otherwise indicated, all numbers used in the specification and claims are to be understood as being modified in all instances by the term “about.” Accordingly, unless indicated to the contrary, the numerical parameters set forth in the following specification and attached claims are approximations that may vary depending at least upon the specific analytical technique, the applicable embodiment, or other variation according to the particular configuration of the battery pack power system.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the present invention as expressed in the appended claims.

1. A battery pack power system, comprising:
a plurality of modular, portable, battery modules having various capacities that can be mixed and matched with one another into a first battery power pack configuration to provide power to a first load application, and then disassembled and re-assembled in a second battery power pack configured to provide power to a second load application;
one or more connectors for electrically connecting the battery modules to one another and that permits only one-way, correct-orientation connection of the battery modules to one another, the flexible connectors having no exposed electrically conductive surfaces;
wherein the individual battery modules are nestable with one another to permit one or more users to each separately transport modules to a desired location and then combine the modules to assemble the battery power pack configuration.

2. The battery pack power system of claim 1 wherein the battery modules have at least one nesting recess on one side and at least one nesting element on an opposite side, the nesting recess on one battery module configured to receive the nesting element on an adjacent module, so that the battery modules may be stacked one atop another into a stack.

3. The battery pack power system of claim 2 wherein the nesting elements and recesses have an elongated shape, and the nesting elements comprise a resilient and tacky material.

4. The battery pack power system of claim 1 wherein opposite sides of the battery modules further comprise a retainer recess and a retainer link configured to receive a retention device to secure the nested battery modules as an assembly, and wherein the retention device comprises an adjustable strap.

5. The battery pack power system of claim 1 wherein the battery modules include a charge indicator that identifies the real-time charge state of the battery module.

6. The battery pack power system of claim 1 wherein the battery modules are rechargeable from an electric grid connection, a vehicle 12 VDC connection, and a portable solar photovoltaic panel.

7. The battery pack power system of claim 1 further comprising an inverter module that is connectable to any one of the battery modules, and operates at 110 VAC in a first mode and 220 VAC in a second mode.

8. The battery pack power system of claim 7 wherein the inverter module further comprises a voltage selector switch, and an indicator light identifying the output voltage level.

9. The battery pack power system of claim 7 wherein the inverter module is configured for use with AC loads and DC loads.

10. The battery pack power system of claim 7 wherein the inverter module includes a multi-standard socket configured to receive any of a plurality of electric plug configurations

11. The battery pack power system of claim 7 wherein the inverter module further comprises output connectors configured to receive USB plugs, 12V barrel connectors, and 12V cigarette lighter connectors.

12. The battery power pack system of claim 1 wherein the battery modules include a readily accessible fuse box with a spring-biased door configured to facilitate troubleshooting of the battery module and permit fuses to be checked and replaced.

13. The battery power pack system of claim 1 wherein the battery modules comprise lithium ion phosphate battery modules.

14. The battery power pack system of claim 1 wherein a first-size battery module has a capacity of approximately 50 watt-hours and another-size battery module has a capacity of approximately 120 watt-hours and the inverter module has a rating or approximately 100 watts.

15. The battery power pack system of claim 1 further comprising a portable solar photovoltaic power generator connectable to one of the battery modules to recharge all of the battery modules.

16. The battery power pack system of claim 1 further comprising a portable wind power generator connectable to one of the battery modules to recharge all of the battery modules.

17. The battery power pack system of claim 1 further comprising a portable hydropower generator connectable to one of the battery modules to recharge all of the battery modules.

18. The battery pack power system of claim 1 wherein the battery modules have a ventilation flow path that permits the free flow of air when the modules are connected to one another.

19. The battery power pack system of claim 1 wherein the battery modules comprise a handle projecting above a top surface and a recess on a bottom surface configured to receive the handle of an adjacent battery module in a nesting and connecting relationship.

20. The battery power pack system of claim 1 wherein the battery modules comprise a recess configured to receive a retainer device disposed about the plurality of battery modules.

21. The battery power pack system of claim 1 wherein the battery modules comprise lead-acid battery modules.

22. The battery power pack system of claim 1 wherein the battery modules have a capacity of approximately 400 watt-hours and the inverter module has a rating or approximately 400 watts.

23. The battery power pack system of claim 1 wherein the connectors comprise elongated flexible connectors for connecting the battery modules to one another in a chained configuration.
